(19) United States
(12) Patent Application Publication
(10) Pub. No.: US 2020/0364564 A1
(43) Pub. Date: Nov. 19, 2020

(54) DATA PROCESSING SYSTEMS AND METHODS USING A NEURAL NETWORK FOR GENERATING VEHICLE ENCODING

(71) Applicant: FAIR IP, LLC, Santa Monica, CA (US)

(72) Inventors: Abhishek Barnwal, Santa Monica, CA (US); David Scott Boren, Woodland Hills, CA (US)

(21) Appl. No.: 16/874,410

(22) Filed: May 14, 2020

Related U.S. Application Data
(60) Provisional application No. 62/849,566, filed on May 17, 2019.

(51) Int. Cl. G06N 3/08; G06N 3/04

(52) U.S. Cl. CPC G06N 3/08; G06N 3/04

(57) ABSTRACT

Systems, methods and products in which a neural network is trained with a set of feed records constructed using information from both item-specific records and item type records to generate a self-defined vector space in which vehicle characteristic vectors can be defined. The trained neural network then generates a vehicle characteristic vectors for each of a set of inventory records. Consumer usage data is collected and a vehicle of interest is identified. A vehicle characteristic vector encoding the vehicle of interest is generated, and is used to compute a dot product as a similarity score for each inventory record's vehicle characteristic vector. The scores corresponding to the different inventory records are ranked, and a notification is provided to the consumer identifying inventory records that are similar to the vehicle of interest.

### RELATED APPLICATIONS

This application claims priority under 35 U.S.C. § 119(e) to United States Provisional Patent Application No. 62/849,566, entitled “DATA PROCESSING SYSTEMS AND METHODS USING A NEURAL NETWORK FOR GENERATING VEHICLE ENCODING”, filed May 17, 2019, which is fully incorporated herein by reference for all purposes.

### TECHNICAL FIELD

The present disclosure relates generally to the field of data processing systems and methods and more particularly to data processing systems and methods in which a neural network generates vehicle encodings and uses the vehicle encodings to determine similarities between vehicles.

### BACKGROUND

One of the objectives of an automotive data processing system is to present to consumers vehicles that they are likely to find desirable. This may involve enabling a consumer to select a vehicle that the consumer finds desirable, and then identifying vehicles that are similar to the selected vehicle. From the perspective of the operator of the automotive data processing system, it would be desirable to be able to accomplish this objective without having to have a human manually identify similar vehicles. Even if the automotive data system can use computers to select similar vehicles, these computers must traditionally be manually configured by knowledgeable persons to classify different characteristics of the vehicles so that their similarity or dissimilarity can be determined by the computer. This requires the time, effort and expense of a person who is experienced and knowledgeable about the many different vehicles that may be considered (not merely knowledgeable about the configuration of the computer), so that this person can map out the similarities between the different vehicles.

People who are very familiar with different vehicles may be familiar with the overall vehicle attributes of many different vehicles, such as the cost, the horsepower generated, the weight, and so on. For instance, a person who is knowledgeable about vehicles would understand that a Toyota Corolla, in terms of overall vehicle attributes, may be very similar to a Nissan Altima, or Hyundai Sonata. This person could therefore identify these vehicles as similar and, if a consumer identifies one of these vehicles as desirable, the knowledgeable person would know that there is a likelihood that the consumer would find the other vehicles to be desirable as well. Without the specialized knowledge of the knowledgeable person, however, there is no basis for mapping these vehicles to each other or identifying them as similar.

### SUMMARY

The systems, methods and products disclosed herein eliminate the need for the specialized knowledge of this person, and also eliminate the need for the time and expense associated with having this knowledgeable person program a computer with the specialized knowledge. The disclosed embodiments also eliminate the subjectivity of having a person (or more likely multiple persons) having to determine similarities between vehicles based on their own individual knowledge and experience. The embodiments disclosed herein instead use a neural network to interpret available verbal descriptions of vehicles and generate, without human intervention, dimensions for characterizing vehicles so that numerical vectors using the defined dimensions can be generated. The numerical vectors comprise encodings of the characteristics of vehicles, quantified in a way that enables numerical comparisons of the vehicles to identify, in a quantifiable way, similarities or dissimilarities between vehicles. This quantifiable comparison can then be used to automatically identify vehicles that are similar to one which has been identified by a consumer as a desirable vehicle. The similar vehicles can then be presented to the consumer, for example, in emails that invite the consumer to explore these similar vehicles, or through a user interface of an app (e.g., where vehicles may be ranked based in part on this similarity).

One embodiment comprises a method implemented in a vehicle data system. In this method, a neural network is executed by the vehicle data system. The neural network is trained with a set of feed records, where each feed record information corresponds to an individual vehicle. Each feed record is constructed with a first portion of information from an item-specific record (e.g., from a dealer management system or inventory system) and a second portion of information from an item type record (e.g., a chrome record). During the training, the neural network generates a self-defined vector space in which vehicle characteristic vectors can be defined. The trained neural network is then used to generate a vehicle characteristic vector encoding each of a set of inventory records. Usage data corresponding to a consumer's usage activity on the vehicle data system is collected and used to identify a vehicle of interest (e.g., a vehicle that the consumer has explicitly selected, or a vehicle which has features that are selected by the consumer or that are identifiable from the consumer's viewing activity). A vehicle characteristic vector encoding the vehicle of interest is then generated. For each of the inventory records, a similarity score is generated based on the corresponding vehicle characteristic vector and the vehicle characteristic vector for the vehicle of interest. This score may, for example, be generated by computing a dot product of the two vectors. The scores corresponding to the different inventory records may be ranked, and a notification may be provided to the consumer identifying one or more of the inventory records based on the ranking of the similarity scores for the inventory records.

The feed records may be constructed by extracting different pieces of textual information from inventory records and the vehicle type records, and combining the different pieces of textual information in a feed record. The information extracted each inventory record is included in exactly one feed record, while information extracted each vehicle type record may be included in one or more feed records. Each feed record may also include one or more pieces of information that are generated by the vehicle data system and are not contained in the inventory records or the vehicle type records. Each feed record may contains an initial portion at a beginning of the feed record and a subsequent portion that follows the initial portion. The initial portion may include pieces of information that are more important to a similarity determination, such as make, model, trim, and value, while the subsequent portion may include pieces of information that are less important for this purpose (e.g., suspension, weight, fuel type, etc.).

One alternative embodiment comprises a system having a processor and a non-transitory computer-readable storage medium that stores computer instructions translatable by the processor to perform a method substantially as described herein. Another embodiment comprises a computer program product having a non-transitory computer-readable storage medium that stores computer instructions translatable by a processor to perform a method substantially as described herein. Numerous other embodiments are also possible.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE FIGURES

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 is a high level block diagram illustrating the structure of an automotive data processing system in accordance with one embodiment.

FIG. 2 is a block diagram illustrating the training of a neural network in accordance with one embodiment.

FIG. 3 is a flow diagram illustrating a method for training a neural network in accordance with one embodiment.

FIG. 4 is a block diagram illustrating the generation of vehicle characteristic vectors by a neural network in accordance with one embodiment.

FIG. 5 is a flow diagram illustrating a method for generating vehicle characteristic vectors using a neural network in accordance with one embodiment.

FIG. 6 is a block diagram illustrating the identification of vehicle similarities and providing corresponding notifications to a consumer in accordance with one embodiment.

FIG. 7 is a flow diagram illustrating a method for identifying vehicle similarities and providing corresponding notifications to a consumer in accordance with one embodiment.

FIG. 8 is a diagram illustrating a distributed network computing environment in which some embodiments may be implemented.

### DETAILED DESCRIPTION

Internet-based systems and other networked computer systems that facilitate purchasing (buying or leasing) automobiles have become increasingly important tools for both consumers and dealers. For example, vehicle search services provided through the Internet have revolutionized the process of searching for vehicles. Dealer management systems (DMS) have also become available for the management of finance, sales, parts, inventory and other aspects of running a dealership.

The process of purchasing a vehicle through a dealership typically involves several distinct steps including: i) vehicle search and selection, ii) a test drive, iii) price negotiation, iv) third party loan approval, v) selection of financing and insurance (F&I) options, and vi) document generation and execution. In a typical scenario, a consumer looking to purchase a vehicle wanders dealer lots or uses the various different web sites that may be provided by dealers and third parties to locate vehicles of interest. If the consumer finds a vehicle that they wish to purchase, they may have to negotiate a price with the dealer, obtain financing for the vehicle and execute paperwork to complete the purchase.

When a consumer is using an application to search for a vehicle to purchase, the consumer may have a specific vehicle that he is interested in, but may not be aware of other vehicles that are similar (i.e., that may have the same features as the vehicle with which the consumer is familiar). The consumer may therefore search for a specific vehicle made by a first manufacturer, but may not search for other vehicles that are made by different manufacturers, but which have similar cost, performance and features as the specific vehicle made by the first manufacturer. It would be helpful if the application that the consumer uses to search for the specific vehicle could identify other vehicles that are similar, so that these similar vehicles could be presented to the consumer as alternatives.

Determining which vehicles are similar to each other (and which vehicles are not) conventionally requires that a person who is familiar with many different types of vehicles map the similar vehicles to each other. These knowledgeable people may manually identify vehicles that can be grouped together as being similar, and may then implement these mappings in computer systems to allow them to identify similar groups of vehicles. This conventional approach may, however, present a number of problems.

For instance, this approach requires that knowledgeable people (“car guys”) be retained to establish the mappings of similar vehicles, and it requires time for these knowledgeable people to create the mappings. Conventional methods may therefore be inefficient, both in terms of the time and cost to create and implement the mappings. The mappings generated by the knowledgeable people may also be subjective, and may differ, depending upon who, in particular, creates the mapping. A mapping made by one person may therefore group certain vehicles together while leaving out vehicles that other knowledgeable people would consider just as similar. Moreover, because of the large number of vehicles that may need to be considered and mapped, and the vast amount of data on their respective features, the manual mapping of similar vehicles may not even be possible as a practical matter.

This disclosure describes systems, methods and products that can more efficiently generate desired information that identifies vehicle characteristics which can be used to distinguish vehicles or determine similarities between vehicles and eliminate the need for persons with specialized knowledge to control or configure systems for identifying similar vehicles. Disclosed embodiments use a neural network that uses a set of verbal vehicle descriptions to generate numerical vehicle description vectors that encode the characteristics of the corresponding vehicles. The neural network does not require intervention from a user to determine the dimensions of the vector space for the vectors, but instead self-defines the dimensions. In other words, the dimensions of the vector space are determined by the neural network based on the available verbal descriptions associated with each vehicle. Users of the system may not know or even understand what characteristic or combination of characteristics is represented by each dimension.

In one embodiment, verbal vehicle descriptions are obtained for a first set of vehicles. These vehicle descriptions are used as a training set for the neural network. In one embodiment, the description for each vehicle includes an identifier and basic information for the vehicle such as the make, model and year, as well as several categorical descriptions regarding the engine size, body size, weight, power, and MSRP (manufacturer's suggested retail price). The records also include descriptions of the options that are available on each vehicle. The neural network processes the records of the training set and generates vectors that include dimensions determined by the neural network itself, rather than by a user. After the neural network has been trained, a consumer-selected vehicle is provided to the neural network, which then compares a neural network-generated vector associated with the selected vehicle to neural network-generated vectors for each of a set of other vehicles. Each comparison comprises computing a dot product of the vector for the consumer-selected vehicle and the vector for the comparison vehicle. The dot product of two vectors A {a₁, a₂, . . . aₙ} and B {b₁, b₂, . . . bₙ} is the sum of the products of the respective vector components, and can be expressed as:

A·B=sum(a₁·b₁,a₂·b₂, . . . aₙ·bₙ)

The dot product provides a score that is a measure of the similarity between the pair of vehicles. Based on the score associated with each of the compared vehicles, a set of vehicles similar to the consumer-selected vehicle can be identified. In one embodiment, the similar vehicles may be presented to the consumer through an email that invites the consumer to view one or more of the vehicles. Alternatively, the similar vehicles may be presented to the consumer through an interface of a consumer application, or used as the basis for ranking vehicles that are presented to the consumer through the application (where rankings of the similar vehicles are increased because of the similarity). The notifications may include links that can be activated by the consumer to view the vehicles identified in the notification.

The invention and various features and advantageous details thereof are explained more fully with reference to the exemplary, and therefore non-limiting, embodiments illustrated in the detailed description herein and accompanying drawings. It should be understood, however, that the detailed description and the specific examples, while indicating the preferred embodiments, are given by way of illustration only and not by way of limitation. Descriptions of known programming techniques, computer software, hardware, operating platforms and protocols may be omitted so as not to unnecessarily obscure the disclosure in detail. Various substitutions, modifications, additions and/or rearrangements within the spirit and/or scope of the underlying inventive concept will become apparent to those skilled in the art from this disclosure.

The present disclosure relates in general to systems, methods and products using a neural network that receives verbal vehicle description records and uses these records to for training, where the neural network generates numerical vehicle description vectors for the vehicle records without intervention by a human to define the vectors. The vehicle description vectors that are generated by the neural network are stored for use by the automotive data processing system. When a vehicle of interest is identified (e.g., by consumer selection of a particular vehicle), the identified vehicle is compared to the inventory vehicles by computing a dot product for each of the corresponding vehicle vectors with the vector for the identified vehicle. The dot product represents a similarity score between the pair of vehicles. The inventory vehicles can then be ranked for selection of the vehicles that are most similar to the identified vehicle. The selected vehicle(s) can then be displayed to the consumer, or the consumer can be sent a notification of the similar vehicle(s) so that these vehicles can be viewed at the consumer's convenience.

In one embodiment, the neural network is implemented in a data processing system that automates and facilitates a purchase process, including inventory selection, financing qualification and document generation. In an exemplary embodiment, the system facilitates selection of a vehicle by providing vehicle information to a consumer through an interface on a mobile device. In this context, a “consumer” is any individual, group of individuals, or business entity seeking to purchase a vehicle (or other asset) through the system. The consumer may select a particular vehicle that is used as the basis for determining similarity (i.e., the other vehicles are compared to the selected vehicle). The similarity scores are used to identify vehicles similar to the consumer-selected vehicle, and the similar vehicles are presented to the consumer to facilitate the consumer's search for a vehicle that the consumer may wish to purchase.

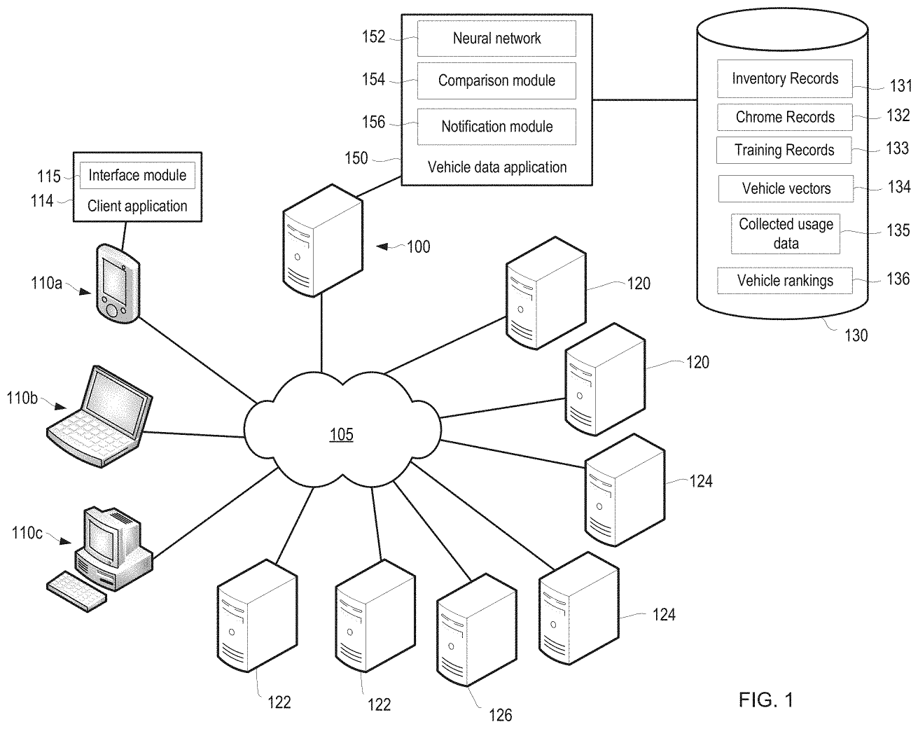

Embodiments of a system for facilitating transactions may be implemented in a network topology. FIG. 1 is a high level block diagram of one embodiment of an example topology. The network topology of FIG. 1 comprises an automotive data processing system 100 which is coupled through network 105 to client computing devices 110 (e.g., computer systems, personal data assistants, smart phones or other client computing devices). Network 105 may be, for example, a wireless or wireline communication network such as the Internet or wide area network (WAN), publicly switched telephone network (PSTN) or any other type of communication link. The system may further include one or more information provider systems 120, one or more dealer management systems (DMS) 122, inventory systems 124, department of motor vehicles (DMV) systems 126 or other systems. Systems coupled to automotive data processing system 100 by network 105 are commonly external to the automotive data processing system and remotely located from the automotive data processing system.

Automotive data processing system 100 may provide a comprehensive computer system for automating and facilitating a purchase process including inventory selection, financing qualification, document generation and transaction finalization, as described in detail in U.S. Patent Application Pub. No. 2018/0204281, which is hereby incorporated by reference. The present disclosure focuses primarily on aspects of the system involving inventory selection, and more particularly components of the system relating to the ranking of displayed inventory items, the tracking of user actions associated with the displayed inventory items, and tuning of the ranking engine that generates the ranking of the displayed inventory items.

Using a client application 114 executing on a client device 110, a consumer user may search dealer inventory, apply for financing, select a vehicle of interest from a dealer and review and execute documents related to the purchase of the vehicle, and execute automated clearing housing (ACH) transactions through automotive data processing system 100 to purchase the vehicle from the dealership.

Turning briefly to the various other entities in the topology FIG. 1, dealers may use a dealer management system (“DMS”) 122 to track or otherwise manage sales, finance, parts, service, inventory and back office administration needs. Since many DMS 122 are Active Server Pages (ASP) based, data may be obtained directly from a DMS 122 with a “key” (for example, an ID and Password with set permissions within the DMS 122) that enables data to be retrieved from the DMS 122. Many dealers may also have one or more web sites which may be accessed over network 105, where inventory and pricing data may be presented on those web sites.

Inventory systems 124 may be systems of, for example, one or more inventory polling companies, inventory management companies or listing aggregators which may obtain and store inventory data from one or more of dealers (for example, obtaining such data from DMS 122). Inventory polling companies are typically commissioned by the dealer to pull data from a DMS 122 and format the data for use on websites and by other systems. Inventory systems 124 may provide information on inventory vehicles that is used in the ranking of the vehicles when they are presented to a consumer, such as prices of the vehicles and locations of the vehicles.

DMV systems 126 may collectively include systems for any type of government entity to which a user provides data related to a vehicle. For example, when a user purchases a vehicle it must be registered with the state (for example, DMV, Secretary of State, etc.) for tax and titling purposes. This data typically includes vehicle features (for example, model year, make, model, mileage, etc.) and sales transaction prices for tax purposes. Additionally, DMVs may maintain tax records of used vehicle transactions, inspection, mileages, etc.).

Information provider systems 120 may be systems of entities that provide information used in approving a user or purchase. Examples of information provider systems 120 may include computer systems controlled by credit bureaus, fraud and ID vendors, vehicle data vendors or financial institutions. A financial institution may be any entity such as a bank, savings and loan, credit union, etc. that provides any type of financial services to a participant involved in the purchase of a vehicle. Information provider systems 120 may comprise any number of other various sources accessible over network 105, which may provide other types of desired data, for example, data used in identity verification, fraud detection, credit checks, credit risk predictions, income predictions, affordability determinations, residual value determinations or other processes.

Automotive data processing system 100 utilizes interfaces configured to, for example, receive and respond to queries from users at client computing devices 110, interface with external information sources such as information provider systems 120, DMS 122, inventory systems 124 and DMV systems 126, obtain data from or provide data obtained or determined by automotive data processing system 100 to any of information provider systems 120, DMS 122, inventory systems 124, DMV systems 126. It will be understood that the particular interface utilized in a given context may depend on the functionality being implemented by automotive data processing system 100, the type of network utilized to communicate with any particular entity, the type of data to be obtained or presented, the time interval at which data is obtained from the entities, the types of systems utilized at the various entities, etc. Thus, these interfaces may include, for example, web pages, web services, a data entry or database application to which data can be entered or otherwise accessed by an operator, APIs, libraries or other type of interface which it is desired to utilize in a particular context.

Client computing devices 110 may comprise one or more computer systems with central processing units executing instructions embodied on one or more computer readable media where the instructions are configured to interface with automotive data processing system 100. A client computing device 110 may comprise, for example, a desktop, laptop, smart phone or other device. According to one embodiment, a client computing device 110 is a mobile device that has a touchscreen display and relies on a virtual keyboard for consumer data input. Client application 114 may be a mobile application (“mobile app”) that runs in a mobile operating system (e.g., Android OS, iOS), and is specifically configured to interface with automotive data processing system 100 to generate application pages for display to a consumer. In another embodiment, the client application 114 may be a web browser on a desktop computer or mobile device. A client computing device 110 may run an application through which a dealer portal can be accessed.

In accordance with one embodiment, a consumer can utilize client application 114 to register with automotive data processing system 100, view inventory, select a vehicle, apply for financing, review documents and finalize a sales transaction through a low friction mobile app running on a smart phone. Client application 114 can be configured with an interface module 115 to communicate data to/from automotive data processing system 100 and generate a user interface for inputting one or more pieces of information or displaying information received from automotive data processing system 100. In some embodiments, the application 114 may comprise a set of application pages through which application 114 collects information from the consumer or which client application 114 populates with data provided via an interface 160. Application 114 may collect information that is manually input by the consumer so that it can be processed by automotive data processing system 100 with other information associated with the consumer. This information can be used to determine, for example, the consumer's qualification for a vehicle purchase, financing options available to the consumer, or pricing for particular vehicles. Application 114 may also collect automatically usage information 135 associated with the consumer's views of displayed vehicles and identification of particular vehicles as favorites or subscribed vehicles. This information may be used to tune the weights that are applied to signals input to a ranking engine that determines an order in which vehicles are displayed to the consumer.

Vehicle data application 150 can comprise a set of processing modules to process obtained data or processed data to generate further processed data. Different combinations of hardware, software, and/or firmware may be provided to enable interconnection between different modules of the system to provide for the obtaining of input information, processing of information and generating outputs.

In the embodiment of FIG. 1, vehicle data application 150 includes a neural network 152, a comparison module 154 and notification module 156. Neural network 152 receives training data in the form of vehicle records 133 that are stored in data store 130. Neural network 152 uses the training data to define the numeric fields or dimensions for a vehicle characteristic vector. After neural network 152 has been trained, vehicle types (e.g., make and model) can be input to neural network 152, which will produce a vehicle characteristic vector for each of the input vehicles. The generated vehicle characteristic vectors 134 can then be saved to data store 130.

Vehicle data application 150 may also include various other modules which are not described in detail herein. These modules may include, for example, dealer interaction modules, user interaction modules, inventory modules, order modules, financing modules, document modules, and various other modules that may be necessary or desirable to perform the functions of the vehicle data application.

The vehicle characteristic vectors generated by the neural network can be compared to a vehicle selected by a consumer to determine the similarity of each vehicle type to the consumer-selected vehicle. This is accomplished by comparison module 154 computing the dot product of the vectors for the consumer-selected vehicle and each of the vehicle types. In other words, the dot product is computed for each pair of vectors, where the pair includes the vector for the consumer-selected vehicle and the vector for one of the vehicle types. The dot product serves as a score that is a measure of the similarity of the two vehicles.

The scores for each of the vehicle types may be stored in data store 130. The scores may alternatively be provided directly to a ranking engine that orders the vehicle types in a ranking 136 according to their respective similarity scores. This order may be used to determine one or more vehicle types which may be provided by notification module 156 to the consumer via email or other notification means. The similarity order of the vehicle types may also be used to determine (or assist in determining) the order in which vehicles are displayed to a consumer through an application interface on a client device.

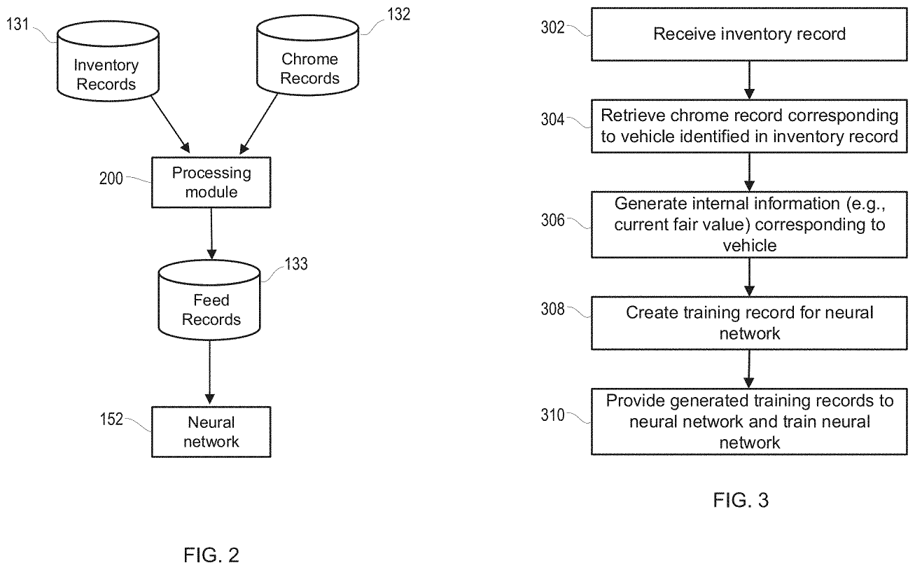

Referring to FIGS. 2 and 3, the training of neural network 152 is illustrated. Neural network 152 is trained using a set of training records (feed records) 133 that are generated based on a set of item-specific inventory records 131 and a set of item type records (e.g., chrome records) 132 which are not item-specific. Each of the training records includes information about a specific Item (e.g., vehicle) that is extracted from a corresponding one of the inventory records, and also includes information about the type of the item (e.g., information associated with a vehicle make, model and trim) extracted from a corresponding one of the item type records 132. Thus, each of the inventory records will be associated with only one of the training records, but each of the item type records may be associated with more than one of the training records.

An exemplary process of generating feed records based on a set of vehicle inventory records is illustrated in FIG. 3. As depicted in this figure, an inventory record for a particular inventory vehicle is first received (302). The inventory record may be received, for example, from a dealer management system, inventory system, or the like. The vehicle type for the particular vehicle is identified, and a corresponding vehicle type record is retrieved (304). As noted above, while the inventory record is associated with one specific vehicle, the vehicle type record is associated with a vehicle type (e.g., make, model, year) that may describe many vehicles and may therefore be applicable to more than one of the vehicles described in the inventory records.

In this example, the system may generate internal information (306) that will be used in conjunction with the vehicle-specific information inventory records and the vehicle type information of the vehicle type records. In one embodiment, the system generates a current fair value for the vehicle. This value may be different from a manufacturer's suggested retail price (MSRP) that may be included in the vehicle type records and an actual dealer price that may be included in an inventory record. Information from each of these different information sources is then combined into a single training record (308). In this embodiment, different pieces of textual information are taken from each of the source records and the pieces are reconstructed into a training record. After the training record is generated, it is provided to the neural network (310). The training records may be provided to the neural network as they are generated, or they may be stored and provided to the neural network in a batch mode to train the neural network.

The pieces of text in each constructed training record are ordered in a way that places more important information toward the beginning of the training record. For instance, the training record may begin with the value, make, model, trim and year of the vehicle, followed by the remaining information from the source records. The remaining information may in some embodiments be added to the training record without regard to its order, except that it follows the value, make, model, trim and year. Placement of the more important information at the beginning of each training record provides an indication of the importance of this information in the training of the neural network, and the neural network places more emphasis on this information when it generates the dimensions of the vehicle characteristic vectors during training.

The inventory records include information which is available from the dealers that hold the vehicles. The inventory records identify specific vehicles and provide information which is specific to those particular vehicles. In one embodiment, each record (which corresponds to a particular one of the inventory vehicles) includes a unique identifier for the vehicle, such as a VIN (vehicle identification number). The record also includes a list of options that the vehicle has. In one embodiment, the options are simply listed in a comma-delimited format (which may alternatively be referred to as a CSV, or comma separated value, format). An illustrative partial listing of the options for an example vehicle is as follows:
{“Stability Control”, “Driver Information System”, “Security Remote Anti-Theft Alarm System”, “Multi-Function Display”, “Crumple Zones Front”, “Crumple Zones Rear”, “Airbags—Front—Dual”, “Air Conditioning—Front—Single Zone”, “Air Conditioning —Front”, “Airbags—Passenger—Occupant Sensing Deactivation”, “Airbags—Front—Side”, “Airbags—Front—Side Curtain”, “Air Conditioning—Air Filtration”, “Airbags—Driver—Knee”, “Emergency Interior Trunk Release”, “Power Brakes”, “Airbags—Rear—Side Curtain”, “Audio Auxiliary Input: IPod/IPhone Integration”, “Assist Handle Front”, “Braking Assist”, “Child Seat Anchors LATCH System”, “Reading Lights Front”, “Child Safety Locks”, “Braking assist hill start assist”, “ABS Brakes (4-Wheel)”
“Front Headrests Adjustable”, “Suspension Rear Coil Springs”, “Suspension Front Spring Type: Coil Springs”, “Suspension Front Arm Type: Lower Control Arms”, “Power Windows: With Safety Reverse”, “Windows Front Wipers: Variable Intermittent”, “Suspension Front Shock Type: Twin-Tube Gas Shock Absorbers”, “Windows Lockout Button”, “Windows Rear Defogger”, “Exterior Mirrors Driver Side Spotter Mirror”, “Seats—Passenger Seat Manual Adjustments: Height”, “Seats—Driver Seat Manual Adjustments: Height”}

The item type records include information about vehicle options that are provided by the original equipment manufacturer for a type of vehicle. For example, chrome records may be obtained through a third-party automotive description service (https://www.chromedata.com/). The information in each chrome record is not associated with a specific vehicle, but instead identifies options that a particular type of vehicle might have (where the type may be defined, for example, by the make, model and year of the vehicle). The chrome record typically includes the type of information that is not normally provided by a dealer. For instance, for a particular vehicle type, the chrome record may include not only the make, model and year of the type of vehicle, but also such information as style, engine description, dimensions and capacities, technical specifications, and original price information.

The chrome record for a specific type of vehicle is used in conjunction with an inventory record for a particular vehicle of that specific type to create a corresponding training record. Typically, various pieces of information that are contained in the chrome record are not available in the inventory record. For instance, the curb weight, dimensions, fuel tank capacity, type of fuel, fuel economy, MSRP (high and low), invoice price (high and low), and similar characteristics of the vehicle are found in the chrome record, but not in the inventory record. The chrome record may also include various other information (e.g., URLs for photographs of the vehicle or other media related to the vehicle) that is not used to form the feed records. An exemplary chrome record (for a 2017 Hyundai Elantra) may include information as follows:
SE 2.0L Auto (Alabama) *Ltd Avail*
{“fuelType”: {“@id”: “1059”, “#text”: “Gasoline Fuel”}, “cylinders”: “4”, “installed”: {“@cause”: “VIN”}, “netTorque”: {“@rpm”: “4500”, “@value”: “132.0”}, “engineType”: {“@id”: “1048”, “#text”: “4 Cylinder Engine”}, “horsepower”: {“@rpm”: “6200”, “@value”: “147.0”}, “@highOutput”: “false”, “fuel Economy”: {“hwy”: {“@low”: “38.0”, “@high”: “38.0”}, “city”: {“@low”: “29.0”, “@high”: “29.0”}, “@unit”: “MPG”}, “displacement”: {“value”: {“#text”: “2.0”, “@unit”: “liters”}}, “fuelCapacity”: {“@low”: “14.0”, “@high”: “14.0”, “@unit”: “gal”}}
[{“value”: {“@value”: “Hyundai Elantra”, “styleId”: “382837”, “@condition”: “ ”}, “definition”: {“group”: {“@id”: “7”, “#text”: “Summary”}, “title”: {“@id”: “1”, “#text”: “Vehicle Name”}, “header”: {“@id”: “16”, “#text”: “Summary”}, “@measurementUnit”: “N/A”}}, {“value”: {“@value”: “Sedan”, “styleId”: “382837”, “@condition”: “ ”}, “definition”: {“group”: {“@id”: “7”, “#text”: “Summary”}, “title”: {“@id”: “2”, “#text”: “Body Style”}, “header”: {“@id”: “16”, “#text”: “Summary”}, “@measurementUnit”: “N/A”}}, {“value”: {“@value”: “Front Wheel Drive”, “styleId”: “382837”,
{“range”: {“@max”: “4.0”, “@min”: “4.0”}, “value”: [{“@value”: “4”, “styleId”: “382837”, “@condition”: “STDEN”}, {“@value”: “4”, “styleId”: “382837”, “@condition”: “ ”}], “definition”: {“group”: {“@id”: “6”, “#text”: “Powertrain”}, “title”: {“@id”: “1121”, “#text”: “Engine Valve Count”}, “header”: {“@id”: “13”, “#text”: “Engine”}}}, {“value”: {“@value”: “United States Hyundai Passenger Cars”, “styleId”: “382837”, “@condition”: “ ”}, “definition”: {“group”: {“@id”: “0”, “#text”: “Vehicle”}, “title”: {“@id”: “1110”, “#text”: “Country of Origin”}, “header”: {“@id”: “0”, “#text”: “Vehicle”}}}]
{“msrp”: {“@low”: “18150.0”, “@high”: “18150.0”}, “invoice”: {“@low”: “17566.0”, “@high”: “17566.0”}, “@unknown”: “false”, “destination”: {“@low”: “885.0”, “@high”: “885.0”}}

As noted above, the information contained in inventory records 131 and chrome records 132 is used to create training records 133. Processing module 200 generates training records 133 combines pieces of information from the inventory records with pieces of information from the chrome records to generate the training records. The training records are generated in a format that places particular pieces of basic information at the beginning of the record, and then includes more general information on the features of the vehicle in the remainder of the record. In some embodiments, each training record may include one or more specific fields in a particular order at the beginning of the record, followed by one or more groupings of information that are more generally defined and may or may not have a particular order, followed by a collection of information that does not have defined content or a defined order.

In one embodiment, the record starts with the unique vehicle identifier and a current fair value for the vehicle. The current fair value for the vehicle may be generated by the automotive data processing system, rather than being retrieved from the inventory or chrome records. In one embodiment, this initial information is followed by model information including the make, model and trim of the vehicle. The record then includes information that classifies the vehicle into various groupings or “bins”. The groupings may, for example, correspond to engine size, body size, curb weight, power, and MSRP. Generally speaking, the information following the unique vehicle identifier and a current fair value is organized with groups of information that are more significant in determining vehicle similarity toward the beginning of the record, and groups of information that are less significant in determining vehicle similarity toward the end of the record.

The foregoing information is included in the order described. Following this information, various pieces of information related to the features of the vehicle are inserted into the training record. An example of a training record is as follows:
Hyundai Elantra SE SE 2.0L Auto (Alabama) *Ltd Avail* mid_size mid-block weak cheap economy light Elantra mid-block mid_size light weak cheap economy stability control driver information system security remote anti-theft alarm system multi-function display crumple zones front crumple zones rear airbags—front—dual air conditioning—front—single zone air conditioning—front airbags—passenger—occupant sensing deactivation airbags—front—side airbags—front—side curtain air conditioning—air filtration airbags—driver—knee emergency interior trunk release power brakes airbags—rear—side curtain audio auxiliary input ipod iphone integration assist handle front braking assist child seat anchors latch system reading lights front child safety locks braking assist hill start assist abs brakes 4-wheel electronic brakeforce distribution front 12 v power outlet 2 center console front console with armrest and storage multi-function remote keyless entry with panic alarm multi-function remote trunk release drivetrain drive mode selector power steering multi-function remote controls fuel filler multi-function remote keyless entry driver seat manual adjustments recline driver seat manual adjustments 6 overhead console trip odometer safety brake pedal system windows solar-tinted glass external temperature display fuel economy display range inside rearview mirror manual day night seatbelts emergency locking retractors driver fuel economy display mpg seats premium cloth upholstery rear seats split folding warnings and reminders lamp failure low fuel engine oil coolant mirror color body-color seatbelts seatbelt force limiters front exterior mirrors power trip computer seatbelts seatbelt warning sensor driver and passenger headlights halogen front seatbelts 3-point front suspension classification independent impact absorbing bumpers traction control seatbelts second row 3-point energy absorbing steering column passenger seat manual adjustments recline tail and brake lights rear center brakelight rear bumper color body-color body side reinforcements side impact door beams rear seats 60-40 split bench digital odometer exterior mirrors manual folding tachometer seatbelts seatbelt pretensioners front passenger seat manual adjustments 6 vanity mirrors dual fixed rear headrests front suspension type macpherson struts seats front seat type bucket rear seats rear heat vents daytime running lights one-touch windows 1 front headrests adjustable suspension rear coil springs suspension front spring type coil springs suspension front arm type lower control arms power windows with safety reverse windows front wipers variable intermittent suspension front shock type twin-tube gas shock absorbers windows lockout button windows rear defogger exterior mirrors driver side spotter mirror seats—passenger seat manual adjustments height seats—driver seat manual adjustments height

The training record may include information that is not contained in the inventory or chrome records, but is instead new information that is determined by the automotive data processing system and inserted into the training record. System-generated information such as current fair value or power-to-weight ratio, which may be useful to the classification of vehicles may also be included in the training records. Additionally, information for the groupings is generated by the automotive data processing system. In the example record above, the identified groupings are: vehicle category—mid_size; engine category—mid-block; horsepower category—weak; price category 1—cheap; price category 2—economy; weight category—light.

In one embodiment, the automotive data processing system creates a training record for each of the inventory vehicles that is stored in the system. Once the training records have been created for each of these vehicles, the training records are fed to the neural network. The neural network is a two-layer neural network that processes text records and generates numerical feature vectors (which may be referred to herein as vehicle characteristic vectors). One exemplary embodiment uses Word2Vec as the basis for the neural network. The vehicle characteristic vector space is not defined by a system operator or other user, but is instead generated by the neural network without human intervention or control, based upon the words in the records of the training set. A user may, however, set the number of dimensions (e.g., 100) that will be included in the vectors.

During the process of training, the neural network learns the relationships between the words that are associated with each make and model. One instance of a training record may correspond to a Toyota Corolla. This vehicle is a low-horsepower, lightweight, economy car. The record therefore contains words that describe this type of vehicle. These words give context to the identification of the vehicle as a Toyota Corolla. Similarly, the words “Toyota Corolla” give context to the surrounding (e.g., following) descriptive terms. The neural network is programmed to identify the vehicle (a Toyota Corolla) and then look at the words that surround “Toyota Corolla” to determine what type of words are associated with this vehicle. Likewise, the neural network looks at the words surrounding the different types of vehicles in each of the training records to determine which words are associated with those vehicles. Depending upon how often particular words appear in the context of the respective makes and models identified in the training records, the neural network will associate different words with the different makes and models.

The neural network will then develop a vector space having dimensions that are associated with the various words that appear in the training records. The dimensions of this self-defined vector space may or may not have a one-to-one correspondence to particular characteristics or particular words, and may not even be understandable to a user of the system. In other words, a particular dimension of the vector space need not be associated with a single characteristic, such as a make or model of the vehicle. Each dimension of the vector space may be associated with one word or characteristic, or a combination of words and characteristics. The characteristic vectors which are defined in this vector space may appear to a user to simply be meaningless sets of values. In some embodiments, the words and/or characteristics associated with each of the dimensions of the vector space are maintained internally and are unknown to (or hidden from) users of the system.

During the course of training, the neural network has generated the different dimensions of the vector space, and has developed sets of weights which are associated with the different dimensions, so that vehicle records which contain similar terms (particularly toward the beginning of the records) are represented by characteristic vectors which produce higher similarity scores for comparisons of more similar vehicles and lower similarity scores for comparisons of less similar vehicles. Whatever vector space is defined by the neural network, the neural network can determine characteristic vectors in the self-defined vector space for each different vehicle record, and can determine similarities between these vectors, even if a user cannot.

The training of the neural network may be validated by first defining certain clusters of vehicles. The clusters may be defined to include, for example, economy cars, SUVs, entry-level luxury cars, and so on. The better trained the neural network is, the more similar vehicles within a particular cluster will appear, in terms of their respective vehicle characteristic vectors. In other words, the similarity scores between vehicles within the same cluster should increase, while the similarity scores between vehicles in different clusters should decrease. From another perspective, the variance between vectors within a cluster should decrease with better training.

The neural network may be trained using, for example, records for all of the vehicles that have been in the system's inventory for the last six months. This may include records for hundreds of thousands of vehicles. In one embodiment, the neural network is re-trained every 2 to 3 weeks using the preceding six months' worth of inventory records. In this embodiment, each time the neural network is re-trained, the vehicle characteristic vectors for each of the vehicles in the current inventory is re-generated. As new vehicles are added to the inventory between trainings of the neural network, the new vehicle records are processed to determine the associated vectors, and the vehicles and corresponding vectors are added to the stored records for the inventory.

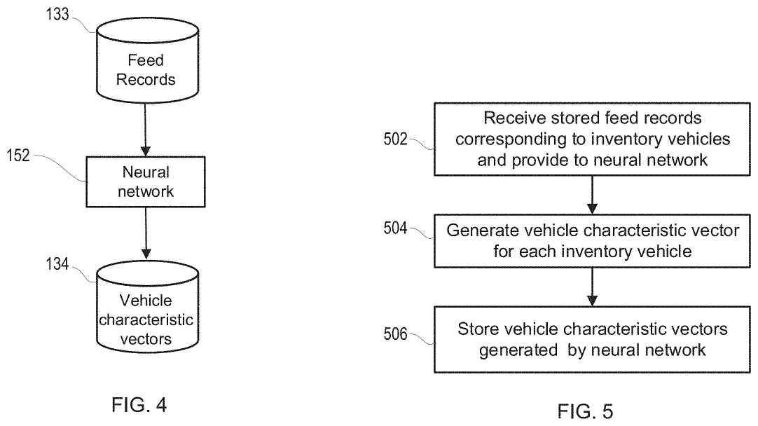

After the neural network has been trained, vectors for individual combinations of make and model can be generated and output by the neural network. Referring to FIGS. 4 and 5, the make and model of each vehicle in inventory records 131 is fed to the neural network in order to generate a corresponding vehicle characteristic vector 134. Because some of the inventory records will likely identify the same combination of make and model, it may not be necessary to separately process all records that have the same combination. The vehicle characteristic vectors that are output by the neural network for each combination of make and model are stored in data store 130 so that they can be used by the automotive data processing system for the purpose of determining similarities between the inventory vehicles and consumer-selected vehicles.

FIG. 5 illustrates this process. In one embodiment, the feed records that were used to train the neural network are again provided to the neural network (502). In this instance, the records are provided to the neural network so that the neural network can generate vehicle characteristic vectors (504) for each of the vehicles. During training (see FIGS. 2 and 3), the neural network does not generate vectors for the corresponding feed records, but instead uses the records to generate the dimensions for the vectors. When the feed records are again processed by the neural network as shown in FIGS. 4 and 5, the vehicle characteristics of each vehicle are quantified according to the dimensions that were developed in the training phase. After a vehicle characteristic vector is generated for each feed record, the vehicle characteristic vectors are stored for use by the system (506).

As noted above, the vehicle characteristic vector space is defined by the neural network rather than by a human. The vectors may therefore appear to be nonsensical to a user. A vector for a particular vehicle will include a set of values (e.g., decimal values such as 0.5, −0.25, 1.3—and so on) that may have no recognizable relationship to any particular features or options. For example it may be that none of the vector values has a value of 4 corresponding to the number of doors on the vehicle, or a value of 300 corresponding to the vehicle's horsepower, or a value of 25 corresponding to the vehicle's fuel economy. Nevertheless, each vehicle will have a value associated with each dimension of the vector space as defined by the neural network, and this value will be representative of the vehicle according to the feature or combination of features defined by the neural network for the corresponding dimension of the vector space.

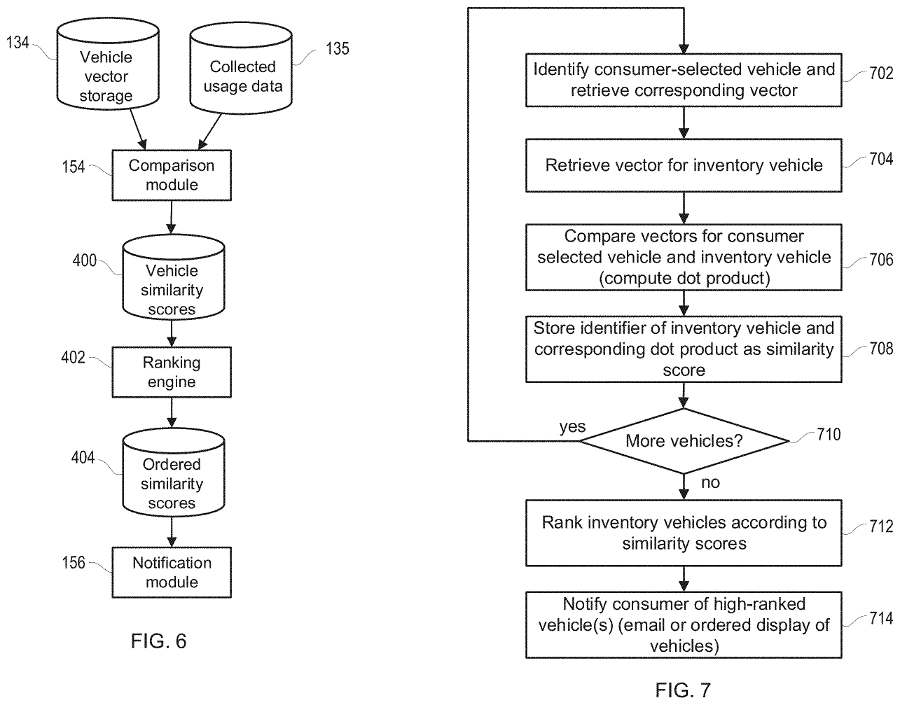

Referring to FIGS. 6 and 7, the vehicle characteristic vectors that have been output by the neural network and stored in the data store can be used by the automotive data processing system to determine the similarity of each of the inventory vehicles to a consumer-selected vehicle. As the consumer uses the system (e.g., using an app on a mobile phone or other client device connected to the automotive data processing system via a network), the consumer may select a particular vehicle in which the consumer is interested. The consumer may, for example, input the make and model of a vehicle in the app, or may select one of a set of displayed vehicles by choosing the vehicle as a favorite. Alternatively, the system may collect information on the consumer's viewing activity (e.g., vehicles which are viewed or liked by the consumer), or it may identify features in which the consumer more specifically indicates an interest. In either case, a vehicle of interest (actual or virtual) is identified for the consumer based on the usage information 135 collected by the system (702).

If a particular vehicle is selected by the consumer, the vehicle characteristic vector for the selected vehicle is obtained (702) by, for example, retrieving it from the vector storage 134 if the vehicle is one of the vehicles for which a vehicle characteristic vector exists, or by newly generating a vector for the vehicle. The vehicle characteristic vector for the selected vehicle is provided to a comparison module 154 of the automotive data processing system. The system also retrieves vehicle characteristic vectors for vehicles in the inventory (704).

In one embodiment, the vectors are provided to comparison 154 module in pairs—each pair including the vector for the selected vehicle make and model, and the vector for the make and model of one of the inventory vehicles. The comparison module compares the vectors (706) by computing the dot product of the two vectors. The dot product serves as a similarity score which indicates the similarity of the inventory vehicle to the selected vehicle. The score for the inventory vehicle is stored (708) in data store 400 with an identifier of the vehicle type (make and model). This is repeated for each of the inventory vehicle types (710). The vector for a particular combination of make and model may also be associated with each of the inventory records that identifies that combination of make and model.

After all of the inventory vehicles have been scored and stored in data store 400, the records of the vehicles and corresponding similarity scores 400 are provided to ranking engine 402. The ranking engine orders the vehicles according to their respective similarity scores (712). The ranked list of vehicles may comprise a partial ranking, as the number of vehicles may be large enough that it is unnecessary to order vehicles below a certain level. For example, if there are 1000 vehicle inventory records, and only the 100 most similar vehicles are of interest, there is no need to determine a specific rank for vehicles that have lower similarity scores than the 100th ranked vehicle. In one embodiment, the ranked list of vehicles 404 is then output to an interface of a mobile device provided to a notification module 156. The ranked list of vehicles may be filtered according to various criteria (e.g., location, price, etc.) to remove one or more of the vehicles before it is provided to the notification module.

Notification module 156 is configured to identify one or more of the vehicles that are ranked at the top of the list (i.e., the vehicles that are most similar to the consumer-selected vehicle). Notification module 156 may be configured to identify only the top-ranked vehicle, or it may identify a group of vehicles (e.g., top three vehicles, or all of the vehicles that are within a desired range of the consumer-selected vehicle). Notification module 156 then provides a notification to the consumer of the identified similar vehicles (714). In one embodiment, the notification comprises an email to the consumer indicating that the identified vehicle is similar to the vehicle previously selected by the consumer and suggesting that the consumer view the similar vehicle. Alternatively, the ordered listing of ranked vehicles could be used as the basis for generating a display for the consumer to view directly through the app. In other words, just as the app may present a set of vehicles to be displayed to the consumer in an order which goes from lowest cost to greatest cost, the vehicles could be ranked from most similar to least similar to the selected vehicle.

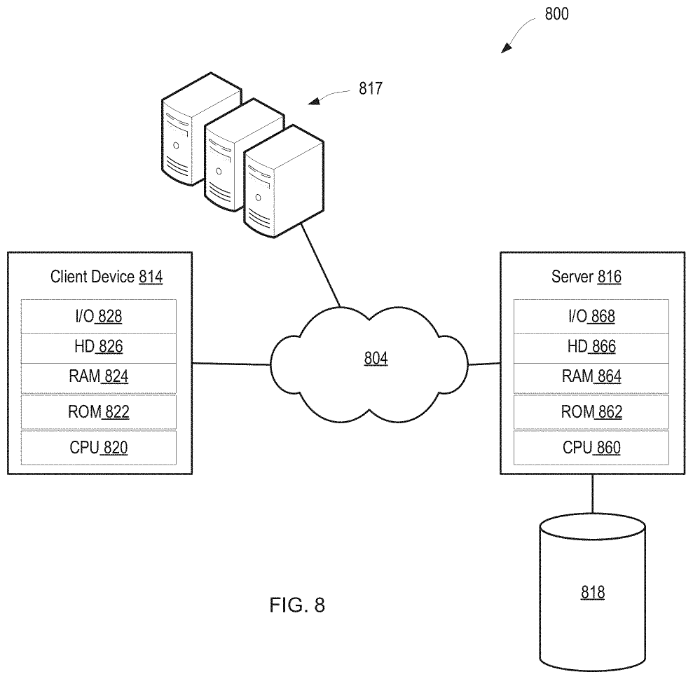

FIG. 8 depicts a diagrammatic representation of a distributed network computing environment where embodiments disclosed can be implemented. In the example illustrated, network computing environment 800 includes network 804 that can be bi-directionally coupled to a client computing device 814, a server system 816 and one or more third party systems 817. Server system 816 can be bi-directionally coupled to data store 818. Network 804 may represent a combination of wired and wireless networks that network computing environment 800 may utilize for various types of network communications known to those skilled in the art.

For the purpose of illustration, a single system is shown for each of client computing device 814 and server system 816. However, a plurality of computers may be interconnected to each other over network 804. For example, a plurality client computing devices 814 and server systems 816 may be coupled to network 804.

Client computer device 814 can include central processing unit (“CPU”) 820, read-only memory (“ROM”) 822, random access memory (“RAM”) 824, hard drive (“HD”) or storage memory 826, and input/output device(s) (“I/O”) 828. I/O 828 can include a keyboard, monitor, printer, electronic pointing device (e.g., mouse, trackball, stylus, etc.), or the like. In one embodiment I/O 828 comprises a touch screen interface and a virtual keyboard. Client computer device 814 may implement software instructions to provide a client application configured to communicate with an automotive data processing system. Likewise, server system 816 may include CPU 860, ROM 862, RAM 864, HD 866, and I/O 868. Server system 816 may implement software instructions to implement a variety of services for an automotive data processing system. These services may utilize data stored in data store 818 and obtain data from third party systems 817. Many other alternative configurations are possible and known to skilled artisans.

Each of the computers in FIG. 8 may have more than one CPU, ROM, RAM, HD, I/O, or other hardware components. For the sake of brevity, each computer is illustrated as having one of each of the hardware components, even if more than one is used. Each of computers 814 and 816 is an example of a data processing system. ROM 822 and 862; RAM 824 and 864; HD 826, and 866; and data store 818 can include media that can be read by CPU 820 or 860. Therefore, these types of memories include non-transitory computer-readable storage media. These memories may be internal or external to computers 814 or 816.

Portions of the methods described herein may be implemented in suitable software code that may reside within ROM 822 or 862; RAM 824 or 864; or HD 826 or 866. The instructions may be stored as software code elements on a data storage array, magnetic tape, floppy diskette, optical storage device, or other appropriate data processing system readable medium or storage device.

Those skilled in the relevant art will appreciate that the invention can be implemented or practiced with other computer system configurations, including without limitation multi-processor systems, network devices, mini-computers, mainframe computers, data processors, and the like. The invention can be embodied in a computer or data processor that is specifically programmed, configured, or constructed to perform the functions described in detail herein. The invention can also be employed in distributed computing environments, where tasks or modules are performed by remote processing devices, which are linked through a communications network such as a local area network (LAN), WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like.

Any suitable programming language can be used to implement the routines, methods or programs of embodiments of the invention described herein. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented.

Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nanoengineered systems, components and mechanisms may be used. The functions of the invention can be achieved by distributed or networked systems. Communication or transfer (or otherwise moving from one place to another) of data may be wired, wireless, or by any other means.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited only those elements but may include other elements not expressly listed or inherent to such process, article, or apparatus. Further, unless expressly stated to the contrary, “or” refers to an inclusive or and not to an exclusive or. For example, a condition “A or B” is satisfied by any one of the following: A is true (or present) and B is false (or not present), A is false (or not present) and B is true (or present), and both A and B are true (or present).

To the extent particular values are provided in any example embodiments in the description, such values are provided by way of example and not limitation. Moreover, while in some embodiments rules may use hardcoded values, in other embodiments rules may use flexible values. In one embodiment, one or more of the values may be specified in a registry, allowing the value(s) to be easily updated without changing the code. The values can be changed, for example, in response to analyzing system performance.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A method implemented in a vehicle data system comprising:
executing a neural network of a vehicle data system;
training the neural network with a set of feed records, wherein each feed record information corresponds to an individual vehicle and comprises a first portion of information from an item-specific record and a second portion of information from an item type record;
for each of a plurality of inventory records, generating by the neural network a vehicle characteristic vector encoding the inventory record;
collecting usage data corresponding to a consumer's usage activity on the vehicle data system;
identifying a vehicle of interest from the collected usage data;
generating a vehicle characteristic vector encoding the vehicle of interest;
generating a score for each inventory record based on the corresponding vehicle characteristic vector and the vehicle characteristic vector for the vehicle of interest; and
providing a notification identifying one or more of the inventory records based on a rank of the inventory record scores.

2. The method of claim 1, wherein generating the score for each inventory record comprises computing a dot product of the vehicle characteristic vector encoding the vehicle record with the vehicle characteristic vector encoding the vehicle of interest, wherein the score comprises the dot product.

3. The method of claim 1, further comprising generating the feed records from the set of inventory records and a set of vehicle type records, wherein information extracted each inventory record is included in exactly one feed record, and wherein information extracted each vehicle type record is included in one or more feed records.

4. The method of claim 3, wherein each feed record includes one or more pieces of information that are generated by the vehicle data system and are not contained in the inventory records and the vehicle type records.

5. The method of claim 3, wherein each feed record contains an initial portion at a beginning of the feed record and a subsequent portion that follows the initial portion, wherein the initial portion includes a set of defined fields in a defined order, and wherein the subsequent portion includes remaining information other than the defined fields of the initial portion in an unspecified order.

6. The method of claim 5, wherein the initial portion includes at least a make of the vehicle and a model of the vehicle.

7. The method of claim 3, wherein the inventory records are retrieved from a first data source and the item type records are retrieved from a second data source which is different from the first data source.

8. The method of claim 1, wherein during the training of the neural network, the neural network generates a self-defined vector space, wherein each of the vehicle characteristic vectors includes a plurality of values, wherein each of the values corresponds to one of the dimensions of the self-defined vector space.

9. A system for generating vehicle encodings, the system comprising:
one or more processors communicatively coupled to one or more data storage devices, the one or more processors coupled to a non-transitory computer-readable medium that stores instructions which are executable by the processor to cause the processor to perform:
executing a neural network of a vehicle data system;
training the neural network with a set of feed records, wherein each feed record information corresponds to an individual vehicle and comprises a first portion of information from an item-specific record and a second portion of information from an item type record;
for each of a plurality of inventory records, generating by the neural network a vehicle characteristic vector encoding the inventory record;
collecting usage data corresponding to a consumer's usage activity on the vehicle data system;
identifying a vehicle of interest from the collected usage data;
generating a vehicle characteristic vector encoding the vehicle of interest;
generating a score for each inventory record based on the corresponding vehicle characteristic vector and the vehicle characteristic vector for the vehicle of interest; and
providing a notification identifying one or more of the inventory records based on a rank of the inventory record scores.

10. The system of claim 9, wherein generating the score for each inventory record comprises computing a dot product of the vehicle characteristic vector encoding the vehicle record with the vehicle characteristic vector encoding the vehicle of interest, wherein the score comprises the dot product.

11. The system of claim 9, further comprising generating the feed records from the set of inventory records and a set of vehicle type records, wherein information extracted each inventory record is included in exactly one feed record, and wherein information extracted each vehicle type record is included in one or more feed records.

12. The system of claim 11, wherein each feed record includes one or more pieces of information that are generated by the vehicle data system and are not contained in the inventory records and the vehicle type records.

13. The system of claim 11, wherein each feed record contains an initial portion at a beginning of the feed record and a subsequent portion that follows the initial portion, wherein the initial portion includes a set of defined fields in a defined order, and wherein the subsequent portion includes remaining information other than the defined fields of the initial portion in an unspecified order.

14. The system of claim 9, wherein during the training of the neural network, the neural network generates a self-defined vector space, wherein each of the vehicle characteristic vectors includes a plurality of values, wherein each of the values corresponds to one of the dimensions of the self-defined vector space.

15. A computer program product for generating vehicle encodings, the computer program product comprising a non-transitory computer-readable medium storing instructions executable by a processor to cause the processor to perform:
executing a neural network of a vehicle data system;
training the neural network with a set of feed records, wherein each feed record information corresponds to an individual vehicle and comprises a first portion of information from an item-specific record and a second portion of information from an item type record;
for each of a plurality of inventory records, generating by the neural network a vehicle characteristic vector encoding the inventory record;
collecting usage data corresponding to a consumer's usage activity on the vehicle data system;
identifying a vehicle of interest from the collected usage data;
generating a vehicle characteristic vector encoding the vehicle of interest;
generating a score for each inventory record based on the corresponding vehicle characteristic vector and the vehicle characteristic vector for the vehicle of interest; and
providing a notification identifying one or more of the inventory records based on a rank of the inventory record scores.

16. The computer program product of claim 15, wherein generating the score for each inventory record comprises computing a dot product of the vehicle characteristic vector encoding the vehicle record with the vehicle characteristic vector encoding the vehicle of interest, wherein the score comprises the dot product.

17. The computer program product of claim 15, further comprising generating the feed records from the set of inventory records and a set of vehicle type records, wherein information extracted each inventory record is included in exactly one feed record, and wherein information extracted each vehicle type record is included in one or more feed records.

18. The computer program product of claim 17, wherein each feed record includes one or more pieces of information that are generated by the vehicle data system and are not contained in the inventory records and the vehicle type records.

19. The computer program product of claim 17, wherein each feed record contains an initial portion at a beginning of the feed record and a subsequent portion that follows the initial portion, wherein the initial portion includes a set of defined fields in a defined order, and wherein the subsequent portion includes remaining information other than the defined fields of the initial portion in an unspecified order.

20. The computer program product of claim 15, wherein during the training of the neural network, the neural network generates a self-defined vector space, wherein each of the vehicle characteristic vectors includes a plurality of values, wherein each of the values corresponds to one of the dimensions of the self-defined vector space.
